(19) United States
(12) Patent Application Publication
(10) Pub. No.: US 2020/0015487 A1
(43) Pub. Date: Jan. 16, 2020

(54) SYSTEM AND METHOD FOR PREPARING MEAT PRODUCTS

(71) Applicant: James Scott Donnel, Fort Collins, CO (US)

(72) Inventor: James Scott Donnel, Fort Collins, CO (US)

(21) Appl. No.: 16/036,444

(22) Filed: Jul. 16, 2018

(51) Int. Cl. A22C 15/00; A22C 17/00; A23L 13/70; A23L 5/10

(52) U.S. Cl. CPC A22C 15/007; A22C 15/008; A23B 4/044; A23L 13/70; A23L 5/10; A22C 17/0093

(57) ABSTRACT

A method and system for preparing meat products is provided. In various embodiments, methods and systems for preparing and producing jerky are provided. Embodiments of the present disclosure comprise structure for efficiently distributing, moving, marinating and preparing meat products including jerky. Enhanced efficiencies for jerky production and marinade usage are provided.

### FIELD

The present disclosure relates generally to methods and systems for preparing food. More specifically, embodiments of the present disclosure relate to methods of handling, preparing and producing meat products. Certain embodiments of the present discourse relate to methods and systems for handling and preparing jerky. As used herein, the term “jerky” is not limited to any particular animal product. Jerky includes, but is not limited to, meat product formed from any one or more of bovine, fowl, porcine, caprine, poultry, and aquatic animals.

### BACKGROUND

Existing methods of producing jerky products generally comprise marinating or seasoning thawed meat in a batch form where the meat product is loose. The product is marinated or seasoned for a desired amount of time and later transferred to a cooking or drying operation. Existing processes are labor intensive and inefficient.

### SUMMARY

Accordingly, there has been a long-felt but unmet need to provide a method and system for handling, preparing and cooking jerky in a more efficient manner. There further exists a need to provide methods and systems that reduce the amount of handling required during jerky preparation, as well as a need to increase the safety of jerky-production operations with respect to both the manufacturers and consumers of the product.

In various embodiments, a method of preparing meat products for consumption is provided. In one embodiment, a method is provided wherein a seasoning, marinade or sauce is provided and placed within a tank, bin or receptacle. A meat product (e.g. turkey, beef, salmon, yak, etc.) is cut, carved or sliced to a desired thickness. In some embodiments, it is contemplated that the meat product is sliced while in a frozen or semi-frozen state. The sliced meat product is then placed onto one or more screens, and the meat product(s) are preferably spaced to minimize contact between adjacent meat product. The one or more screens are provided on a magazine that is operable to receive a plurality of screens. The magazine or frame comprising one or more screens is then transferred to the tank, bin or receptacle comprising the marinade. The magazine comprising screens and meat product is allowed to marinate for a period of time (e.g. 1-12 hours). After the period of time has elapsed, the screens are removed from the tanks and the meat is cooked and/or dried. In preferred embodiments, the racks comprising meat product are inserted into cooking racks or “trucks.” The truck(s) are then moved to a cooking oven, dehydrator or smokehouse. In various embodiments, the meat product is cooked at specific temperature settings for a period of time (e.g. 1-2 hours) and/or until the meat product is provided at a specific temperature (e.g. 160 degrees F.). Once the desired cook time and/or temperature is achieved, the meat product is removed from the oven, smoker, or smokehouse and allowed to cool. After cooling, the meat product is packaged and ready for shipment, sale, consumption, etc.

In various embodiments, a system for preparing and producing meat product is provided. Systems of the present disclosure contemplate devices and features for handling, preparing and cooking meat. In certain embodiments, systems of the present disclosure comprise one or more of: a screen, a magazine, a lifting harness, a soaking tank, a magazine cart, a gantry, hoist, and hoist hook, a cooking truck, a trief slicer, and an oven, dehydrator or similar apparatus.

In various embodiments of the present disclosure, screens or racks are provided to support and handle meat products. Screens or racks of the present disclosure generally comprise metal racks with a grate member to support the weight of meat products and allow liquid marinade (for example) to pass through the rack and contact meat products. The racks are moveable and are operable to be stacked, provided within a lifting frame, and/or provided within an oven or similar device.

In various embodiments, systems and devices for supporting racks are contemplated. In some embodiments, a magazine, cage, or lifting frame is provided that is operable to receive, support and transport a plurality of racks. The lifting frame(s) of the present disclosure comprise a support structure as shown and described herein that is operable and arranged to support the weight of a plurality of racks and associated meat products. The lifting frame(s) preferably comprise an at least partially open construction wherein fluid (air, marinade, etc.) is allowed to flow through at least one side or portion of the lifting frame and expose meat products to the fluid. The lifting frame is operable to receive various forces, including tension forces applied during lifting and transportation of a plurality of stacked racks and associated meat products. As used herein, the terms “magazine”, “cage”, and “lifting frame” may be used interchangeably. In various embodiments, racks and lifting frames are provided such that the racks are stacked directly adjacent to one another in a manner that prevents meat products from being displaced or floating, particularly when submerged in a liquid marinade.

In various embodiments, an upper frame member is provided that comprises an upper portion of a lifting frame. The upper frame member is contemplated as being selectively securable to the lifting frame. The upper frame member preferably comprises a lift point such as a welded hook, eyelet or similar member to receive a lifting device. In some embodiments, the upper frame member is secured to the lifting frame by one or more pins.

In various embodiments, at least one soaking or marinating tank is provided. Tanks of the present disclosure are contemplated as comprising an internal volume to receive a liquid marinade, and wherein the internal volume is sized to receive at least one lifting frame. An assembled lifting frame, including associated racks and meat products may be placed within the internal volume to enable a marinating step. In preferred embodiments, the internal volume of the tank is only slightly larger than the external dimensions of the lifting frame to minimize an amount of liquid marinade required.

In various embodiments, a cart is provided that comprises wheels and a drip pan. Carts of the present disclosure are useful for and operable to prepare and assemble a plurality of stacked racks within a lifting frame. The lifting frame and carts are sized such that carts comprise a means for temporarily storing and transporting assembled or partially-assembled lifting frames.

In some embodiments, a gantry assembly, a hoist and a hoist hook are provided to lift and transport racks and lifting frames. In some embodiments, a gantry assembly comprises a built-in fixture of an existing building, such as an overhead beam. In other embodiments, the gantry comprises a portable, self-contained gantry. Hoists of the present disclosure are contemplated as comprising various known hoists including, but not limited to moveable hoists and winches with electric motors. The hoist may comprise a hook for selective communication with lifting frames.

In some embodiments, cooking trucks are provided that are operable to receive and support a plurality of racks. The cooking trucks are operable to be conveyed to the confines of an oven, dehydrator, or smoker to support the meat products during a cooking and/or drying operation. The cooking trucks are also operable for use during a cooling operation wherein meat products are allowed to cool prior to packaging.

In one embodiment, a system for handling and preparing jerky is providing. The system comprises a lifting frame comprising a plurality of horizontal supports and a plurality of vertical supports; an upper frame member that is selectively securable to the lifting frame, and wherein the upper frame member comprises at least one lifting member operable to receive and transmit force to the lifting frame. A plurality of racks is provided that are sized and operable to be received by the lifting frame, each of the plurality of racks comprising at least one of a mesh and a grate that is operable to support a meat product and to allow at least a portion of the meat product to be exposed to an external environment. A tank is provided that comprises an internal volume operable to receive a liquid. The internal volume of the tank is larger than a volume of the lifting frame. A lifting assembly is provided that comprises a motor and a connecting member to selectively communicate with the lifting member of the upper frame member.

In one embodiment, a system for handling and preparing jerky is provided that comprises a lifting frame comprising a plurality of horizontal supports and a plurality of vertical supports. An upper frame member is provided that is selectively securable to the lifting frame, and wherein the upper frame member comprises at least one lifting member operable to receive and transmit force to the lifting frame. A plurality of racks is provided that are sized and operable to be received by the lifting frame, and each of the plurality of racks comprising at least one of a mesh and a grate that is operable to support a meat product and to allow at least a portion of the meat product to be exposed to an external environment. A tank is provided that comprises an internal volume operable to receive a liquid. The internal volume of the tank is preferably larger than a volume of the lifting frame. A lifting assembly is provided that comprises a connecting member that is operable to selectively communicate with at least one of the lifting frame and the upper frame member.

In some embodiments, circulation or agitation of marinade is provided. For example, in certain embodiments, a tank or vessel comprising meat product and marinade comprises a force-transmitting device such as a propeller to agitate and circulate marinade. Such embodiments increase the amount of marinade that contacts the meat product(s) and reduces the volume of marinade that is stagnant and/or not in contact with the meat.

In various embodiments, methods of producing meat products are provided. In one embodiment, a method of producing jerky is provided that comprises the steps of: providing a meat product; slicing the meat product into a plurality of meat segments; providing the meat segments on a plurality of racks; providing the racks in a stacked arrangement, wherein at least a portion of the stacked arrangement is in communication with a lifting frame; providing a tank with an internal volume, and providing a liquid marinade within the internal volume; positioning the lifting frame and each of the plurality of racks within the internal volume of the tank such that each of the plurality of meat segments are in contact with the liquid marinade; allowing the meat segments to rest in contact with the liquid marinade for a predetermined amount of time; removing the lifting frame from the internal volume of the tank by vertically displacing the lifting frame; and conveying the meat segments to at least one further processing step. It is contemplated that the at least one further processing step comprises at least one of cooking the meat segments, cooling the meat segments, seasoning the meat segments and packaging the meat segments. In some embodiments, methods of the present disclosure contemplate subject meat segments to an X-ray imaging process and contemplate evaluating X-ray images of the meat product(s) to determine whether not foreign bodies are present within the meat product(s).

In some embodiments of the present disclosure, a method and system of preparing meat product is provided wherein meat is provided on one or more screens after the meat is sliced. The screen that receives and supports the meat product is preferably used during a marination process and a cooking process, thus reducing labor and handling needs and increasing efficiencies. Additionally, in certain embodiments of the present disclosure, a quantity or volume of marinade that is needed for producing jerky is reduced by a recirculation system and method. In preferred embodiments, a marinade is applied to a meat product and is allowed to drain under the force of gravity. The marinade is preferably collected in a basin or sump feature. A pump is provided in fluid communication with the sump, and the pump is operable to convey the fluid to a location of greater gravitational potential energy where it is reapplied to the meat product. Preferably, the pump is in communication with at least one of an atomizer, a spray gun, a nozzle, a drip hose, a drip bar, a spray bar, or various combinations thereof to redistribute the marinade or other liquid to the meat product.

In one embodiment, a system for handling and preparing jerky is provided, wherein the system comprises a rack member operable to support a meat product and to allow at least a portion of the meat product to be exposed to an external environment. A tank is provided that comprises an internal volume operable to receive the rack member, and the tank comprises a sump in a lower portion of the tank, the sump is operable to receive fluid that is gravity-fed to the sump, the sump comprises at least one outlet, and a conduit is provided in fluid communication with the outlet. A pump is provided in communication with the conduit, wherein the pump is operable to provide a force to convey a fluid from the sump or settling portion. A dispensation device is provided that is operable to dispense a fluid to the rack member.

In yet another embodiment, a system for handling and preparing jerky is provided that comprises a structural member that is operable to support a meat product. A tank is provided that comprises an internal volume operable to receive a fluid. The tank comprises a sump in a lower portion of the tank, the sump is operable to receive fluid that is gravity-fed to the sump. The sump also comprises at least one outlet proximal to a point of lowest gravitational potential energy in the sump. A conduit is provided in fluid communication with the outlet, and a pump is in communication with the outlet, wherein the pump is operable to provide a force to convey a fluid from the sump. A dispensation device is provided that operable to dispense a fluid to components of the system and food product(s).

In yet another embodiment, a system for handling and preparing jerky is provided that comprises a rack member that is operable to support a meat product. A tank is provided that comprises an internal volume operable to receive a fluid and at least a portion of the rack member. The tank comprises a sump in a lower portion of the tank and wherein the sump is operable to receive fluid that is gravity-fed to the sump. The sump comprises at least one outlet proximal to a point of lowest gravitational potential energy in the sump. A dispensation device is provided vertically above the sump and is operable to dispense a fluid to the rack member, and wherein fluid dispensed from the dispensation device is allowed to drain to the sump. A pump is provided in communication with the outlet, wherein the pump is operable to provide a force to convey a fluid from the sump.

In various embodiments, methods of preparing a meat product are provided. In some embodiments, a method of preparing a meat product is provided that comprises the steps of: providing a quantity of meat; slicing the meat into strips of desired thickness; placing the strips onto screens, wherein the screens are supported by a rack member; positioning the screens and the rack member above or within a tank member, wherein the tank member comprises a collection basin for fluid and comprises an outlet; activating at least one of a pump and a valve to dispense and distribute a liquid marinade on the strips; and allowing the marinade to flow onto the meat and into the tank member under the force of gravity.

In various embodiments of the present disclosure, it is contemplated that a plurality of dispensation devices are provided. Various arrangements of dispensation devices are also contemplated. For example, in some embodiments, a plurality of dispensation devices are provided wherein at least one dispensation device is provided and positioned to spray or dispense a liquid from a location vertically above a meat product. At least one additional dispensation device is provided and positioned to spray or dispense a liquid from a location vertically below the meat product, and at least one dispensation device is provided and positioned to spray or dispense a liquid from a location that is vertically aligned or similarly positioned (in the vertical direction) as the meat product. In such embodiments, enhanced coverage is provided wherein the meat product is sprayed or impacted by a fluid (e.g. marinade) from multiple different angles.

In various embodiments, it is contemplated that meat products are provided in a substantially horizontal arrangements wherein the meat products are laid flat on a horizontal racks or screens and subjected to a marination process. In alternative embodiments, however, it is contemplated that meat product is provided in a substantially vertical orientation and subjected to marinade in that orientation. For example, in various embodiments, it is contemplated that sliced meat product may be hung from hooks or clips, or securely held between screens. The meat product is subjected to a flow or spray from marinade. In such embodiments, it is contemplated that at least one dispensation device is provided that is arranged and operable to spray fluid in a direction that is generally horizontal so as to maximize the surface area of the meat product being impacted by the fluid.

U.S. Patent Application Publication No. 2018/0153181 to Appel et al., which is hereby incorporated by reference in its entirety, discloses various systems, devices and methods for processing food product. The systems, methods, and devices provided therein are contemplated as comprising features and systems of the present disclosure including, for example, a recirculation system for a liquid marinade.

Although the present disclosure and the Figures depict systems and devices of various sizes and proportions, it will be recognized that no limitation with respect to the size, shape, or proportions of certain features is provided. For example, tubs and sumps of the present disclosure may be scaled up or down to accommodate processes and methods involving different quantities of meat and marinade, and based on a user's preference. Inventive aspects of the present disclosure reside in features shown and described herein regardless of the particular size as will be recognized by one of ordinary skill in the art.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of these inventions.

FIG. 1 is a perspective view of meat products in combination with components of a system for meat preparation according to one embodiment of the present disclosure.

FIG. 2 is a perspective view of components of a system for meat preparation according to one embodiment of the present disclosure.

FIG. 3A is a perspective view of components of a system for meat preparation according to one embodiment of the present disclosure.

FIG. 3B is a perspective view of components of a system for meat preparation according to the embodiment of FIG. 3A.

FIG. 4 is a perspective view of meat products in combination with components of a system for meat preparation according to one embodiment of the present disclosure.

FIG. 5 is a perspective view of a plurality of racks provided with meat products according to one embodiment of the present disclosure.

FIG. 6 is a perspective view of meat products in combination with components of a system for meat preparation according to one embodiment of the present disclosure.

FIG. 7 is a perspective view of a lifting frame and associated components according to one embodiment of the present disclosure.

FIG. 8 is a perspective view of a lifting frame, soaking tank, and associated components according to one embodiment of the present disclosure.

FIG. 9 is a partially exploded perspective view of a system for preparing meat products according to one embodiment of the present disclosure.

FIG. 10 is a perspective view of the system for preparing meat products according to the embodiment of FIG. 9.

FIG. 11 is a perspective view of the system for preparing meat products according to the embodiment of FIG. 9.

FIG. 12 is a cross-sectional elevation view of a system for preparing meat products according to one embodiment of the present disclosure.

FIG. 13 is a perspective view of a system for preparing meat products according to one embodiment of the present disclosure.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

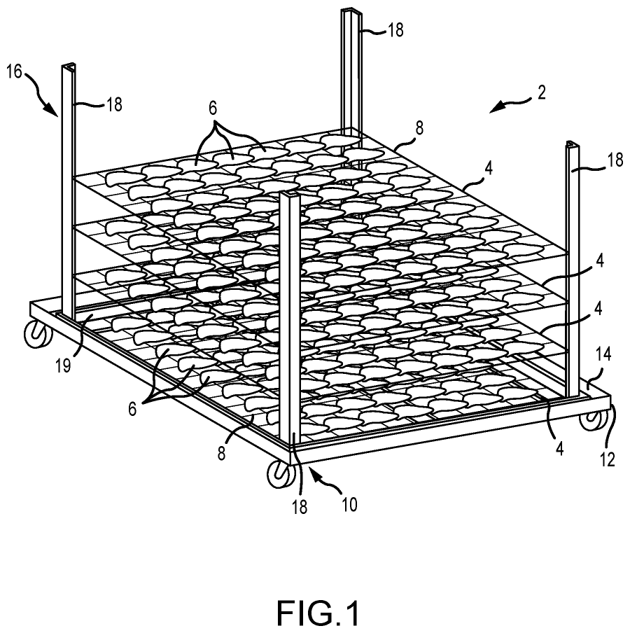

FIG. 1 is a perspective view of a system 2 for preparing food. In various embodiments, the system 2 is contemplated for use with meat products and more specifically for the handling, preparation, cooking, and production of jerky. It will be recognized, however, that methods and systems are not limited to use with any particular meat or food product. Methods, devices and systems as described herein comprise novel features regardless of specific applications or methods of use.

As shown in FIG. 1, the system 2 comprises a plurality of racks 4. The racks 4 comprise metal grates or screens that are operable to support meat product(s). FIG. 1 depicts a plurality of sliced meat segments 6 distributed across a length and width of each rack 4. The racks 4 comprise bars 8 extending in at least one direction and preferably in two or more dimensions of the rack 4. The racks 4 are provided with meat segments 6 and are provided in a stacked arrangement as shown in FIG. 1. In preferred embodiments and methods of the present disclosure, racks 4 with at least partially-frozen meat products are stacked to provide a compressive force to each of the racks and thus prevent meat products from moving, particularly when immersed in a liquid marinade. The racks 4 also provide enough separation to enable marinade (for example) to contact meat product(s) provided on the racks 4.

A cart 10 is provided that comprises a wheel base 12 and removable tray 14. The tray 14 is provided as a removable component with respect to the wheel base 12. The tray 14 provides structural support to the system and serves to collect and catch drippings from the meat segments 6 and various components of the system.

A support structure is provided to receive and support the weight of a plurality of racks 4. In FIG. 1, a support structure in the form of a magazine or lifting frame 16 is provided. The lifting frame comprises a metal frame member with a plurality of vertical supports 18 and a plurality of horizontal supports 20. The vertical supports 18 preferably comprise an angled cross-section. In the embodiment of FIG. 1, the vertical supports 18 comprise a generally L-shaped cross-section that is operable to receive and contain a corner of a rack 4. As shown in FIG. 1, each of the plurality of vertical supports 18 is provided to receive and contain the corners of a plurality of racks 4. In various embodiments, a plurality of racks 4 with meat products provided thereon are stacked in the arrangement shown in FIG. 1. When stacking is complete, the lifting frame 16, racks 4 and associated meat segments 6 are ready for further processing in accordance with the present disclosure.

Although not shown in FIG. 1, an upper frame member is provided and secured to the upper portions of each of the vertical support members 18. The upper frame member comprises a lift point, as shown and described herein, and provides a means for lifting the assembled lifting frame 16 from the cart 10. The assembled lifting frame and associated racks may then be transported to additional locations and process steps.

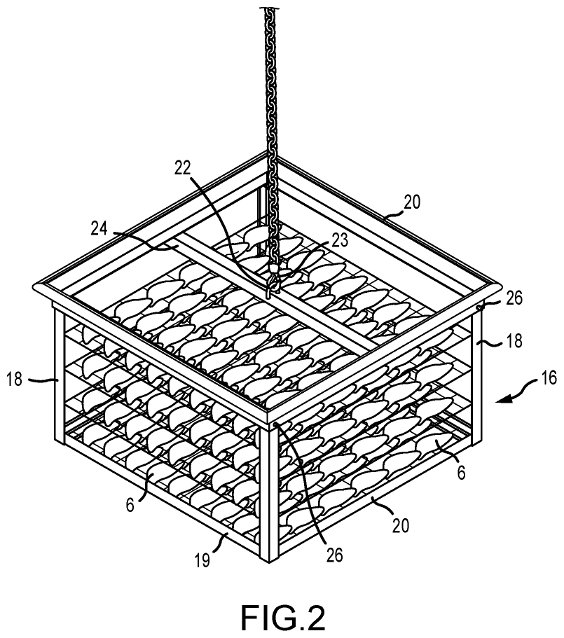

FIG. 2 is a perspective view of a lifting frame 16 provided with an upper frame member 20. The upper frame member 20 is secured to the magazine 16 and comprises a lift-point 22 where a hook 23 or similar lifting member may be attached to lift and/or transport the lifting frame 16. As shown in FIG. 2, the lifting frame 16 has been lifted from the cart of FIG. 1 and is suspended in a manner that enables transportation and relocation of the lifting frame 16, racks 4 and associated meat products 6. The lifting frame 16 as provided in FIG. 2 is operable to be transported to various locations and positions and is operable to be handled and processed in various ways. For example, the devices and arrangement of FIG. 2 are rendered operable to be inserted or lowered into further features of the present disclosure including, but not limited to, a tank for soaking or marinating the meat products.

The upper frame member 20 comprises a rectangular frame member with a center beam 24. The center beam 24 comprises a load-bearing member that is secured to a remainder of the upper frame member 20 and is operable to support the entire weight of the magazine including racks 4, associated meat product(s) 6 and related components. In the depicted embodiment, the upper frame member 20 comprises a plurality of pin connections 26 to selectively secure the upper frame member 20 to the lifting frame 16 at each of the four corners of the upper frame member 20. Although a single center beam 24 is shown in FIG. 2, other embodiments of the present disclosure contemplate the provision of a plurality of beams and structures to support the weight of a loaded magazine. For example, in some embodiments, it is contemplated that the center beam 24 comprises a truss member with greater load capacity than a simple beam. Various truss designs may be employed in such embodiments. It is also contemplated that the center beam 24 may comprise various cross-sections including an I-beam cross section. In some embodiments, a plurality of weight-supporting beams are provided. In one embodiment, a plurality of beams extend at angle from each of the four corners of an upper frame member such that the beams do not comprise horizontal beam members and the lifting force applied by a gantry hook (for example) is not normal to the longitudinal axis of the beam (as shown in the embodiment of FIG. 2, for example).

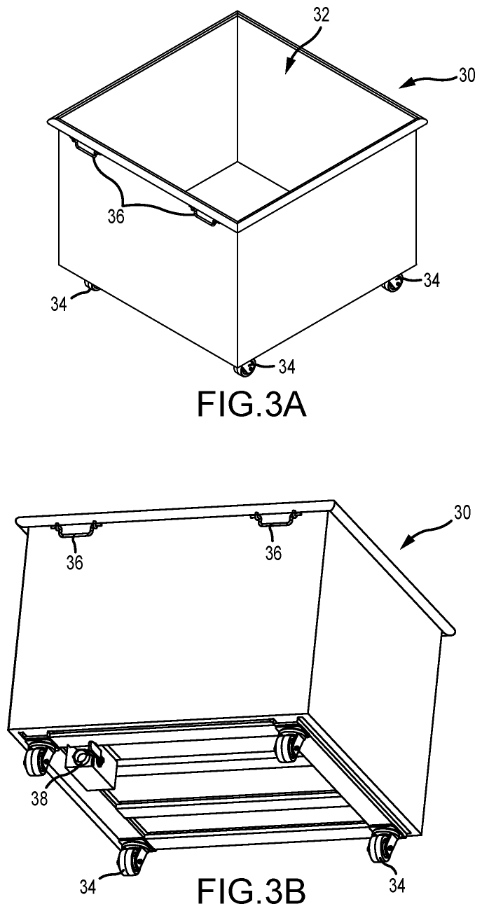

FIG. 3 is a perspective view of a tank 30 according to one embodiment of the present disclosure. The tank 30 of FIG. 3 is operable for use as a soaking and marinating tank for meat products and comprises a component of a system for producing jerky. The tank 30 comprises a rectilinear cube, but it will be expressly recognized that tanks 30 of the present disclosure may comprise various different shapes. In preferred embodiments, however, it is contemplated that the tank 30 comprises dimensions that are slightly larger than the outer dimensions of an assembled lifting frame 16 to provide an efficient system and reduced wasted or unneeded marinade. The tank 30 preferably comprises a stainless steel tank with an internal volume 32 for receiving marinade and meat products. In the depicted embodiment, the tank 30 is provided with a plurality of wheels 34 and handles 36 to facilitate movement of the tank 30. At least one of the wheels 34 preferably comprises a lock or brake mechanism to selectively prevent movement of the tank 30.

A drain valve 38 is provided in communication with a lower portion of the tank 30 to selectively drain contents of the tank 30. In various embodiments, the drain valve comprises at least one of a manually-operated ball valve and a gate valve to empty contents such as used or spent marinade.

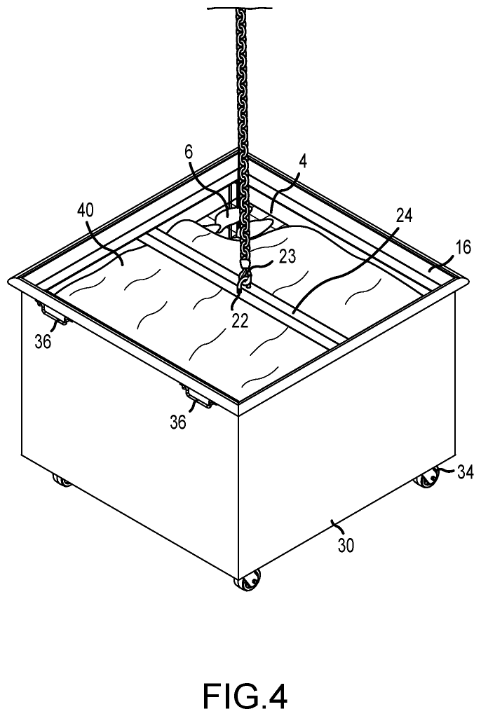

FIG. 4 is a perspective view of a method step and system components of one embodiment of the present disclosure. As shown, a tank 30 is provided. The tank 30 comprises an internal volume for receiving and holding a liquid marinade 40. The internal volume 32 of the tank 30 is further operable to receive a magazine 16 and a plurality of racks associated with the magazine for holding meat products 6. In various embodiments of the present disclosure, methods of preparing jerky comprise the steps of providing an assembled magazine with a plurality of meat products 6 into a tank 30 that comprises marinade 40. The magazine is hoisted and lifted at a load or lift-point 22 and is moved in a vertical and/or horizontal direction to relocate the magazine from an initial position in which it is loaded (see FIG. 1, for example) into a tank 30. The magazine 16 and associated meat products 6 can rest or marinate for a desired period of time (e.g. 6 hours) wherein the meat is fully submersed in the marinade 40 during this period of time. After the desired period of time has elapsed, the magazine 16 and associated meat products are lifted or otherwise removed from the tank 30 and subjected to further process steps (e.g. cooking). In some embodiments, methods of the present disclosure contemplate emptying liquid marinade 40 from the tank 30 prior to lifting the magazine 16 from the tank 30 to reduce the load on lifting equipment. Emptying of the marinade is contemplated as being accomplished by the drain valve 38 provided in the tank 30.

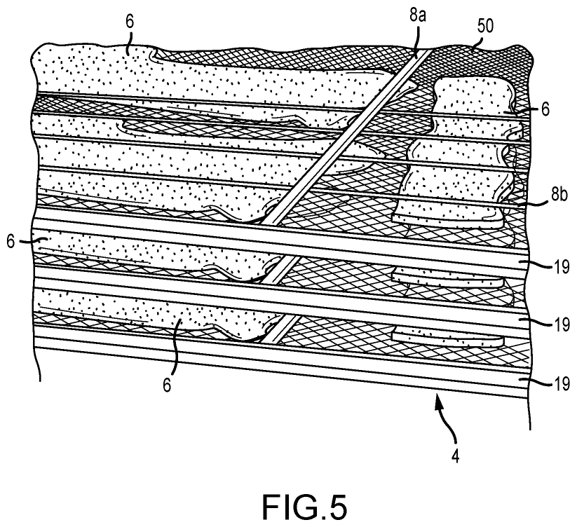

FIG. 5 is a detailed perspective view of a lifting frame 16 after a marinating step. The magazine of FIG. 5 is provided with a plurality of racks 4 comprising mesh screens 50 or grates to support meat products 6 and to allow marinade (not shown in FIG. 5) to contact the surface of the meat. The racks 4 further comprise supports 8a, 8b that are provided substantially perpendicular to one another.

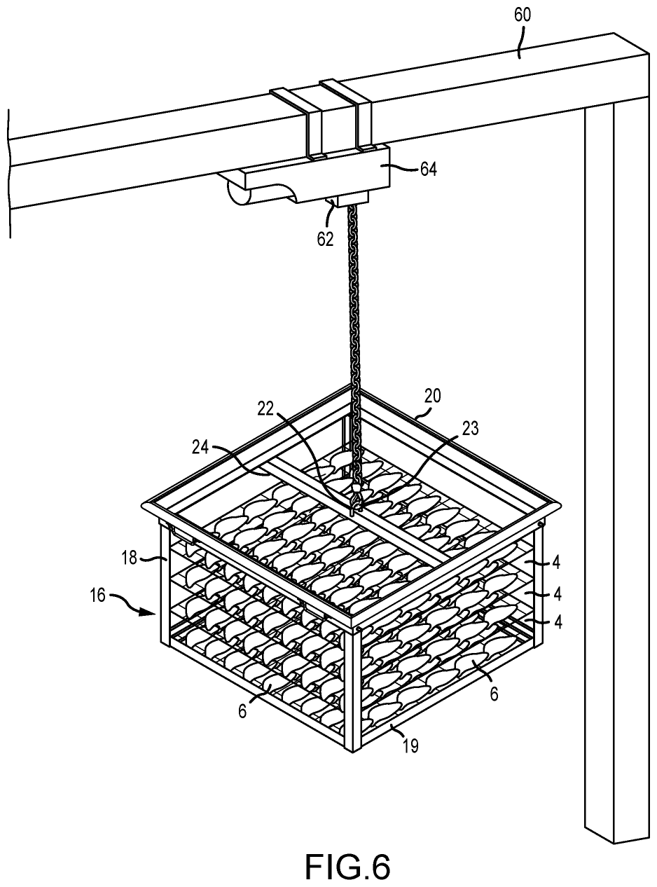

FIG. 6 is a perspective view of a system for meat production according to one embodiment of the present disclosure. As shown, a lifting frame 16 is provided that comprises a plurality of racks 4 and wherein each of the plurality of racks 4 is provided with meat product(s). As will be recognized by one of ordinary skill in the art and as shown and described herein, the magazine as shown in FIG. 6 provides an efficient means of preparing and producing jerky. It will also be recognized that the loaded magazine 16 of FIG. 6 comprises a heavy object that cannot or should not be moved manually. Accordingly, embodiments of the present disclosure including that shown in FIG. 6 provide means and structure for lifting and moving meat production devices. A gantry structure 60 is provided as an overhead support structure to support a hoist 62 and/or hook 64. The gantry structure 60 may be provided as a moveable or portable gantry, or may be an integrated overhead support beam or structure in an existing building. The hoist 62 and motor provide a powered lifting means to lift and/or translate the lifting frame 16 before and/or after a marinating step.

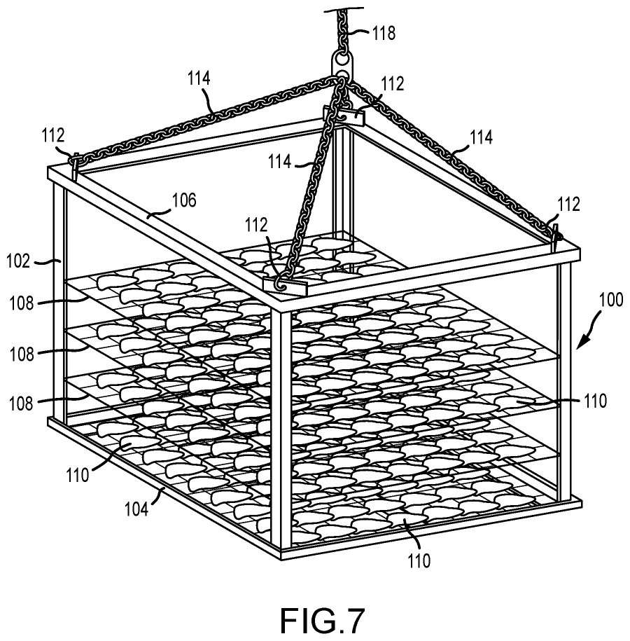

FIG. 7 is a perspective view of a lifting frame 100 according to an alternative embodiment of the present disclosure. As shown, the lifting frame 100 comprises a frame having vertical 102 and horizontal supports 104. The lifting frame 100 is operable to receive a plurality of racks 108 which are provided with sliced meat products 110. An upper frame member 106 is selectively secured to the lifting frame 100. The upper frame member 106 comprises a load point or lift point 112 in each of the four corners of the upper frame member 106. The lifting frame and associated racks may be lifted and/or moved by hoisting the lifting frame from each of the lift points 112. A chain or similar tension member 114 is secured to each of the lift points and, as shown in FIG. 7, each of the chains are connected to a primary lifting chain 118.

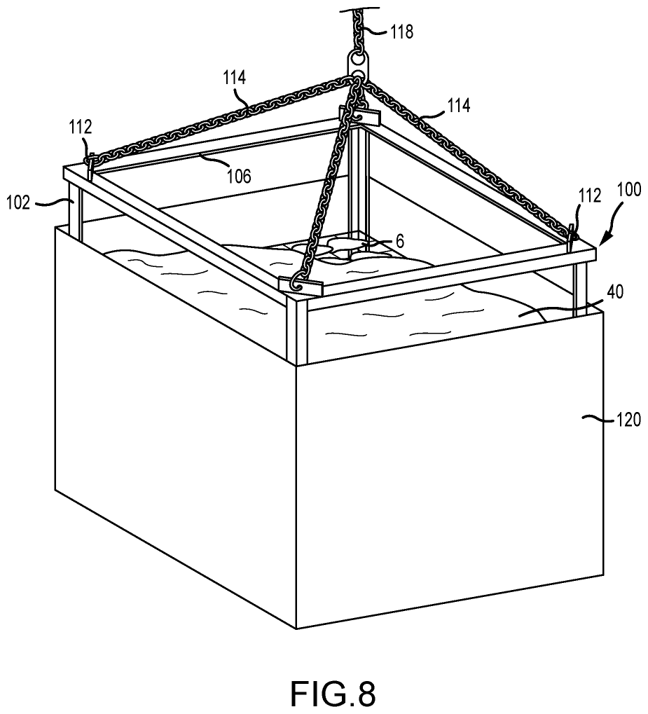

FIG. 8 is a perspective view of the lifting frame 100 of FIG. 7 being provided into a tank 120. The tank 120 is shown as comprising the same or similar construction as that of FIG. 3. As shown in FIG. 8, a lifting frame or magazine is provided that is operable to fit within the confines of a soaking tank 120, and wherein the internal dimensions of the soaking tank 120 are slightly larger than the external dimensions of the lifting frame 116. In various embodiments, a tolerance of between approximately 0.5 and 5.0 inches is provided between the lifting frame 116 and each side of the tank 120.

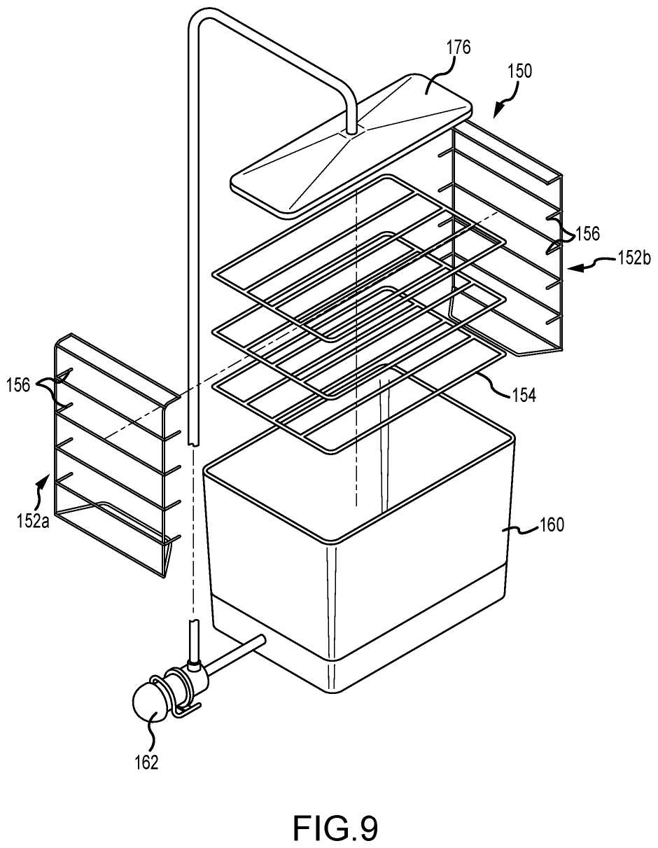

FIG. 9 is a perspective view of a system for preparing meat products according to one embodiment of the present disclosure. The system comprises a structural member or rack member 150. As shown, the rack member 150 comprises substantially vertical support members 152a, 152b that are operable to receive at least one screen 154. The screen or screens 154 are operable to receive and support a food product including, for example, a sliced meat product to be formed into jerky. As shown, the rack member 150 comprises a plurality of horizontal supports 156. Spacing between the screens can be modified by selectively moving the screens (including eliminating screens) from the horizontal supports 156. In preferred embodiments, the supports 156 are spaced apart from one another by at least approximately 2.0 inches, such that a minimum vertical distance between screens 154 is at least approximately 2.0 inches to allow for air and fluid flow between screens and associated meat product (not shown in FIG. 9).

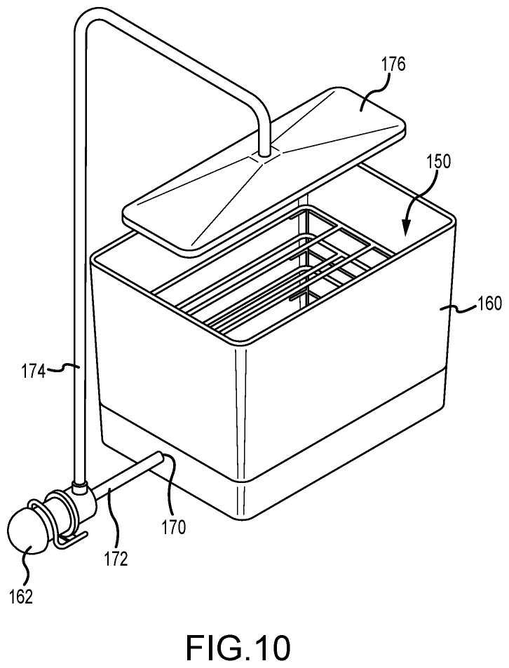

As is further shown in FIG. 9, the system comprises a tank 160 with an associated pump 162 and a dispensation device 176. These features and their operation are described in more detail with respect to FIGS. 10-12.

FIG. 10 is a perspective view of the system of FIG. 9 in an assembled state. A tank 160 is provided and is operable for use in marinating food products, such as jerky. As shown, the tank 160 comprises a vessel that is operable to receive at least a portion of a rack member 150. The tank 160 generally comprises a catch basin for fluid and, as will be shown and described in more detail herein, comprises a collection point or sump to gather fluid. The tank 160 comprises at least one outlet 170 that is in fluid communication with a pump 162. The pump 162 comprises an outlet in fluid communication with a conduit 174 that is operable to convey fluid received from a lower portion of the tank 160 back to an upper portion of the tank and meat product(s) disposed on the rack member 150 associated with the tank 160. In various embodiments, an outlet of the pump 162 is in fluid communication with a dispensation device 176 that comprises at least one of a nozzle, an atomizer, a spray head, a spray bar, and a mister to convey and distribute a fluid (e.g. marinade) to the meat product(s) provided on the rack member 150.

Although various embodiments of the present disclosure contemplate a tub that receives a rack member within the internal volume of the tub, alternative embodiments are contemplated wherein the tub does not surround or envelop the rack member 150. For example, in some embodiments, it is contemplated that a tub is provided that comprises a drip pan and the rack member 150 is positioned vertically above the drip pan. In such embodiments, it is contemplated that the drip pan comprises a collection member and comprises a pump to evacuate fluid from the pan. Drip pans for use with such embodiment need not envelop or surround a rack member, and no limitation with respect to the height of a tub 160 or a drip pan is provided herewith.

As shown, the tank 160 comprises a sump with an outlet 170. The outlet 170 is preferably provided at a point of lowest gravitational potential energy within the tank 160 such that a fluid within the tank is allowed to drain to the outlet 170 under the force of gravity alone. A conduit 172 is connected to the outlet 170 on a first end. A second end of the conduit is preferably in communication with a pump 162. A second conduit or hose 174 is connected to an outlet of the pump and further comprises a dispensation device 176. The dispensation device 176 comprises a spray head that is operable to disperse a stream of fluid and convey the same to meat product including, for example, meat product provided on a rack member 150 provided within a tank 160.

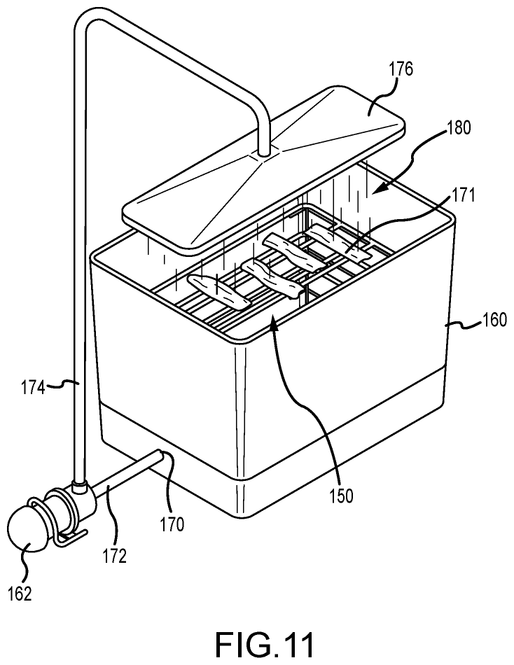

FIG. 11 is a perspective view of the system of FIG. 10 and wherein meat product 171 is provided on the rack member 150. In various embodiments of the present disclosure, systems and methods are provided wherein the meat or food product 171 is vertically and horizontally offset to maximize a surface area of the food product 171 that is impacted by fluid from the dispensation device 176.

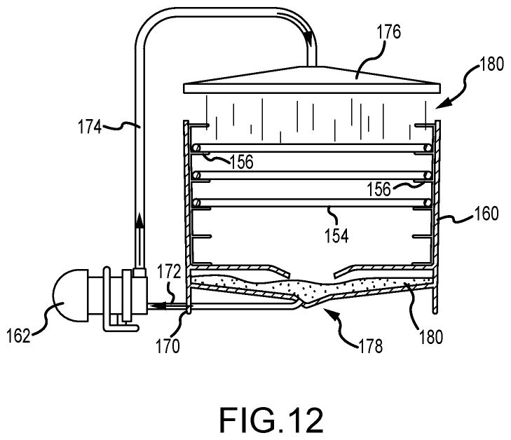

FIG. 12 is a cross-sectional elevation view of a system for preparing meat products according to an embodiment of the present disclosure. As shown, the tank 160 comprises a collection area in the form of a sump 178. The sump 178 comprises a basin wherein fluid 180 (e.g. marinade) is collected. The sump 178 comprises an outlet 170 through which fluid can be expelled, dispensed, or emptied from the internal volume of the tank 160. In some embodiments, the tank 160 comprises a plurality of outlets wherein, for example, one outlet is operable to convey fluid to a pump for recirculation and another outlet is operable to empty and dispose of fluid (when the fluid is deemed to be spent and the process is complete, for example). In further embodiments, it is contemplated that the outlet of the tank comprises a two-way valve, wherein the valve may be selectively operated to divert fluid to an intended location (a recirculation pump or a disposal site, for example). Although the outlet 170 is shown as being positioned in a sidewall of the sump 178, it is also contemplated that one or more outlets are provided in a bottom portion of the sump and, in some embodiments, the bottom walls of the sump are tapered toward the outlet.

As is further shown in FIG. 12, a rack member 150 is provided within the tank 160 and the rack member 150 comprises a plurality of screens 154 for supporting meat product. A pump 162 is operable to receive a fluid 180 from the tank 160 and convey the fluid through a conduit 174 to a dispensation device 176. The dispensation device disperses and delivers the fluid to the screens 154 and associated meat products.

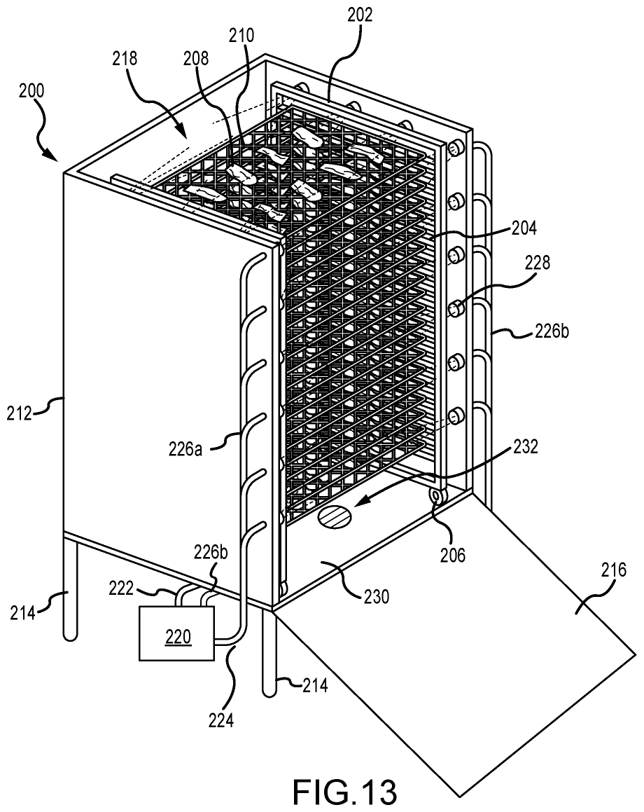

FIG. 13 is a perspective view of a system 200 for handling and preparing food products according to one embodiment of the present disclosure. As shown, the system 200 comprises a cooking rack 202 that is operable to support a plurality of cooking screens 210. The rack 202 of FIG. 13 is shown as comprising a plurality of screens 210 provided within or on slots or rungs 204. The screens 210 are selectively and slidably insertable into the rack 202. Accordingly, the number of screens 210 and relative spacing may be varied. Meat or other food product 208 is provided on the screens 210. The food product 208 is thereby provided in a position for treating food including, for example, subjecting the food to marinade. The rack 202 is provided within an internal volume 218 of a marinade tank 212. The rack 202 preferably comprises wheels 206, and the tank 212 comprises a ramp 216. In some embodiments, the ramp 216 comprises a hinged panel that is selectively rotatable between the ramp position shown in FIG. 13 and a closed position wherein the ramp 216 comprises a fourth wall that encloses the internal volume 218 of the tank 212.

The tank 212 of the embodiment of FIG. 13 comprises a fluid recirculation system for continuously applying a liquid marinade (for example) to the food product 208. Specifically, the tank 212 comprises a base portion 230 with a sump and drain 232 provided therein. The drain is in fluid communication with a pump 220 via a drain line 222. The pump 220 is operable to recirculate fluid from the drain 232 to various regions of the tank 212. In the depicted embodiment, the tank 212 comprises a plurality of spray nozzles 228 distributed throughout the tank. The nozzles 228 are operable to spray fluid to the food product(s) 208 on the screens 210, where it is thereafter allowed to drain through screens and/or be collected on the lower portion 230 and drain back to the pump 220 for further recirculation. A plurality of conduits or hoses 226a, 226b connect the pump 220 and the various nozzles 228. In some embodiments, the nozzles are selectively rotatable or positionable to achieve a desired distribution and spray pattern. In further embodiments, it is contemplated that the nozzles comprise self-rotating nozzles to distribute marinade. Self-rotating nozzles of such embodiments are contemplated as comprising those shown and described in U.S. Pat. No. 7,273,188 to Saha, which is hereby incorporated by reference in its entirety.

The tank 212 of FIG. 13 comprises a plurality of legs 214 to provide the lower portion of the tank in an elevated position relative to a ground or floor surface, and to provide room to accommodate the pump 220 and related components. It should be recognized, however, that the tank 212 may comprise various different configurations, sizes, and shapes while accomplishing the objectives of the present disclosure.

Although various embodiments of the present disclosure contemplate the provision of rectilinear lifting frame, racks, and tanks, it will be recognized that various other geometrical shapes are contemplated for features of the present disclosure. For example, in alternative embodiments, it is contemplated that at least one of a tank, a lifting frame, and a rack are provided with a circular shape. Such alternative shapes may be desirable for various reasons, including but not limited when racks and lifting frames of the present disclosure are to be provided in ovens, dehydrators or smokers of different shapes.

Various different embodiments are provided herein. It is contemplated that the various features of various different embodiments are contemplated for use with other embodiments of the disclosure, even if such a combination is not specifically shown or described herein. One of ordinary skill in the art would readily understand how to combine various inventive features of the present disclosure with other inventive features of the present disclosure.

While various embodiments of the disclosed device have been described in detail, it is apparent that modifications and alterations of those embodiments will occur to those skilled in the art. However, it is to be expressly understood that such modifications and alterations are within the scope and spirit of the present disclosure, as set forth in the following claims. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

The foregoing discussion has been presented for purposes of illustration and description. The foregoing is not intended to limit the disclosure to the form or forms disclosed herein. In the foregoing description for example, various features of the disclosure have been identified. It should be appreciated that these features may be combined together into a single embodiment or in various other combinations as appropriate. The dimensions of the component pieces may also vary, yet still be within the scope of the disclosure. Moreover, though the description has included description of one or more embodiments and certain variations and modifications, other variations and modifications are within the scope of the disclosure, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The present disclosure, in various embodiments, includes components, methods, processes, systems and/or apparatus substantially as depicted and described herein, including various embodiments, subcombinations, and subsets thereof. Those of skill in the art will understand how to make and use the devices of the disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation. Rather, as the following claims reflect, inventive aspects lie in less than all features of any single foregoing disclosed embodiment.

What is claimed is:

1. A system for handling and preparing jerky, the system comprising:
a rack member operable to support a meat product and to allow at least a portion of the meat product to be exposed to an external environment;
a tank comprising an internal volume operable to receive the rack member;
the tank comprising a sump in a lower portion of the tank, the sump operable to receive fluid that is gravity-fed to the sump;
the sump comprising at least one outlet;
a conduit in fluid communication with the outlet;
a pump in communication with the conduit, wherein the pump is operable to provide a force to convey a fluid from the settling portion; and
a dispensation device operable to dispense a fluid to the rack member.

2. The system of claim 1, wherein an inlet of the pump is connected to the conduit, and wherein an outlet of the pump is connected to the dispensation device and the pump is operable to recirculate a fluid within the tank.

3. The system of claim 1, wherein the dispensation device is positioned vertically above the tank.

4. The system of claim 1, wherein the sump comprises a drain valve that is operable to selectively dispense tank contents.

5. The system of claim 1, wherein at least one of the tank and the rack member comprises stainless steel.

6. The system of claim 1, wherein the rack member comprises a support member and a plurality of horizontally-extending screens, the horizontally-extending screens being selectively removable from the support member.

7. The system of claim 6, wherein the horizontally-extending screens are spaced apart from one another by at least approximately 2.0 inches.

8. A system for handling and preparing jerky, the system comprising:
a structural member that is operable to support a meat product;
a tank comprising an internal volume operable to receive a fluid;
the tank comprising a sump in a lower portion of the tank, the sump operable to receive fluid that is gravity-fed to the sump;
the sump comprising at least one outlet proximal to a point of lowest gravitational potential energy in the sump;
a conduit in fluid communication with the outlet;
a pump in communication with the outlet, wherein the pump is operable to provide a force to convey a fluid from the sump; and
a dispensation device operable to dispense a fluid to the structural member.

9. The system of claim 8, wherein an inlet of the pump is connected to the conduit, and wherein an outlet of the pump is connected to the dispensation device and the pump is operable to recirculate a fluid.

10. The system of claim 8, wherein the dispensation device is positioned vertically above the structural member.

11. The system of claim 8, wherein the outlet comprises a drain valve that is operable to selectively dispense tank contents.

12. The system of claim 8, wherein at least one of the tank and the structural member comprises stainless steel.

13. The system of claim 8, wherein the structural member comprises a plurality of horizontally-extending screens, the horizontally-extending screens being selectively removable from the support member.

14. The system of claim 8, wherein the horizontally-extending screens are spaced apart from one another by at least approximately 2.0 inches.

15. A system for handling and preparing jerky, the system comprising:
a rack member that is operable to support a meat product;
a tank comprising an internal volume operable to receive a fluid and at least a portion of the rack member;
the tank comprising a sump in a lower portion of the tank, the sump operable to receive fluid that is gravity-fed to the sump;
the sump comprising at least one outlet proximal to a point of lowest gravitational potential energy in the sump;
a dispensation device provided vertically above the sump and being operable to dispense a fluid to the rack member, and wherein fluid dispensed from the dispensation device is allowed to drain to the sump;
a pump in communication with the outlet, wherein the pump is operable to provide a force to convey a fluid from the sump.

16. The system of claim 15, wherein an inlet of the pump is connected to the outlet of the sump, and wherein an outlet of the pump is connected to the dispensation device and the pump is operable to recirculate a fluid.

17. The system of claim 15, wherein the dispensation device comprises at least one of a nozzle, an atomizer, and a spray head.

18. The system of claim 15, wherein the sump comprises a drain valve that is operable to selectively dispense tank contents.

19. The system of claim 15, wherein at least one of the tank and the rack member comprises stainless steel.

20. The system of claim 15, wherein the rack member comprises a plurality of horizontally-extending screens.
